(19) United States
(12) Patent Application Publication
(10) Pub. No.: US 2011/0043895 A1
(43) Pub. Date: Feb. 24, 2011

(54) WAVELENGTH CONVERTING DEVICE, LASER, AND METHOD TO STABILIZE THE WAVELENGTH CONVERSION EFFICIENCY

(75) Inventor: Rifat Ataa Mustafa Hikmet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/990,523

(22) PCT Filed: Apr. 29, 2009
(86) PCT No.: PCT/IB09/51744

§ 371 Date: Nov. 1, 2010

(30) Foreign Application Priority Data
May 6, 2008 (EP) 08155679.7

(51) Int. Cl. G02F 1/37

(52) U.S. Cl. 359/328

(57) ABSTRACT

Proposed is a wavelength converting device (100) comprising a non-linear optical crystal (10) having periodically poled regions (20,30) with alternating polarity. The device (100) is characterized in that the period (41,42) of the poled regions along an axis (X) of the device vary in a direction (Y) perpendicular to the axis. The invention is based on the insight that a poling period corresponds to a given temperature. Thus, providing different poling periods along a direction in the wavelength converting device advantageously allows correlating the position of the device along that direction with a temperature.

### FIELD OF THE INVENTION

The invention relates to a wavelength converting device comprising a non-linear optical crystal having periodically poled regions with alternating polarity. Furthermore, the invention relates to a laser comprising such a wavelength converting device. Moreover, the invention relates to a method to stabilize the conversion efficiency of such devices.

### BACKGROUND OF THE INVENTION

An embodiment of a wavelength converting device and a laser of the kind set forth are known from U.S. Pat. No. 5,787,102. That document discloses a non-linear optical device applying a periodically poled lithium niobate (PPLN) crystal having regions with an alternating polarity, i.e. inverting the sign of the non-linear optical coefficient. Dispersion in non linear optical materials means that the refractive index n₁ seen by the fundamental wave differs from the refractive index n₃ seen by second harmonic generated light. As a result, the fundamental wave (with wavelength λ) travels at another speed within the material than the second harmonic wave. Due to the different speed a phase shift of π between the generated light and the fundamental wave exist at a so called coherence length L_{c}=λ/4*(n₃−n₁), causing a destructive interference. This periodic poling (also known as quasi-phase-matching) prevents destructive interference of second harmonic light by the introduction an additional phase shift of π at every coherence length. It therefore enables the built up of the energy of the generated second harmonic power. For maximum effect the half of the period of the poled regions equals the coherence length. Thus, if the two waves are in phase at the start of the first coherence length/region, they will be exactly out of phase at the start of the second coherence length/region. Inverting the polarity of the material in the second region, however, synchronizes the phases of the two waves again, effectively allowing a cumulative energy transfer from one wave to the other.

The temperature sensitivity of non-linear optical materials, however, forms a clear limitation of the solution described in U.S. Pat. No. 5,787,102. Variations in the temperature of the wavelength converting device significantly change the refractive indices in the crystal material and thus the coherence length. This results in a considerable decrease in conversion efficiency. Classically, the temperature sensitivity problem has been solved by positioning the non-linear crystal in a temperature stabilized environment by for instance applying a resistively heated oven. This solution shows limited effectiveness and/or is difficult to implement for small size solid-state semiconductor lasers.

Thus, a clear need exists for wavelength conversion devices (and lasers applying such devices) showing low temperature sensitivity. Moreover, a clear need exists for such devices (and lasers) enabled to allow stabilization of the conversion efficiency through compensation of temperature variations.

### SUMMARY OF THE INVENTION

The invention has as an objective providing a wavelength conversion device of the kind set forth which fulfils at least one of the above mentioned needs in part. The invention achieves his objective according to a first aspect with a wavelength converting device comprising a non-linear optical crystal having periodically poled regions with alternating polarity CHARACTERIZED IN THAT the period of the poled regions along an axis (X) of the device vary in a direction (Y) perpendicular to the axis.

The invention is based on the insight that a poling period corresponds to a given temperature. Thus, providing different poling periods along a direction in the wavelength converting device advantageously allows correlating the position of the device along that direction with a temperature.

Wavelength converting devices with varying poling periods are known from U.S. Pat. No. 6,726,763. This document discloses a non-linear crystal a plurality of domains having alternating polarity. In contrast to the invention, however, the poling period of the domains is arranged to vary along an axis (X) (defining the direction light propagates through the crystal) so as to provide non-uniform chirping of phase matching of focused optical signals. Chirping the poling period along the length of the non-linear crystal allows different input-output wavelength sets to become quasi-phase-matched in different portions of the crystal, thus increasing its spectral acceptance. In contrast, chirping the poling period along the width of the crystal allows phase-matching input-output wavelength sets at different temperatures through adjustment of the crystal in the direction (Y) perpendicular to the axis (X) of the crystal.

In an embodiment, the non-linear optical crystal comprises a material chosen from the group consisting of Lithium Niobate (LN), Lithium Tantalate (LT), Litium tri-Borate (LBO), Potassium Titanyl Phosphate (KTP), Potassium Niobate (KN), beta Barium Borate (BBO), Rubidium Titanyl Arsenate (RTA). The materials show high non-linear polarizability and are economically produced as single crystals.

According to a second aspect, the invention provides a laser comprising an inventive wavelength converting device.

In an embodiment of the laser, the position of wavelength converting device in the laser relative to a light beam is arranged to be adjustable along the direction (Y) perpendicular to the axis (X). Advantageously, this allows for compensation of the temperature changes of the device and thus for stabilization of the conversion efficiency.

In an embodiment the laser further comprises a mount on which the wavelength converted device is assembled to allow adjusting its position. In an embodiment the mount is arranged to have a calibrated thermal expansion allowing for stabilization of the conversion efficiency through automatic compensation of temperature variations of the wavelength converting device by displacing it along the direction (Y). In an embodiment the mount comprises an electrical element controllable in length allowing for maximization of the conversion efficiency.

In an embodiment, the laser is arranged as an extend cavity laser and the wavelength converting device is arranged inside the extended cavity. In an alternative embodiment, the wavelength converting device is arranged as an intra-cavity element.

In an embodiment, the wavelength converting device is arranged to generate a second harmonic of a fundamental laser wavelength. In an alternative embodiment, the wavelength converting device is arranged to parametrically generate a signal and idle output.

According to a third aspect, the invention provides a method to stabilize the conversion efficiency of a wavelength converting device comprising a non-linear optical crystal having periodically poled regions with alternating polarity, the method comprising the steps: (i) providing the period of the poled regions along an axis (X) of the device to vary in a direction (Y) perpendicular to the axis, and (ii) adjusting the position of the wavelength converting device along the direction (Y) perpendicular to the axis (X).

In an embodiment, the method further comprises the steps: (iii) assembling the wavelength converting device on a mount, and (iv) arranging the mount to have a calibrated thermal expansion allowing for maximization of the conversion efficiency through automatic compensation of temperature variations of the wavelength converting device by displacing it along the direction (Y).

These and other aspects of the invention will be apparent from and elucidated with reference to the embodiments described hereinafter.

### BRIEF DESCRIPTION OF THE DRAWINGS

Further details, features and advantages of the invention are disclosed in the following description of exemplary and preferred embodiments in connection with the drawings.

FIG. 1 schematically shows a wavelength converting device according to the invention.

FIG. 2 schematically shows an embodiment of a laser comprising a wavelength converting device according to the invention.

### DETAILED DESCRIPTION OF THE EMBODIMENTS

Second order nonlinear effects are usually relatively weak, yet it is possible to use them to generate frequency conversion processes at power levels suitable for practical applications. In sum and difference frequency mixing (SFM, DFM), two input photons, that travel through a nonlinear medium, are added or subtracted into one photon of higher or lower energy: ω₃=ω₁±ω₂. When ω₁=ω₂=ω then ω₃=2ω, the nonlinear susceptibility gives rise to second harmonic generation (SHG). Other types of nonlinear processes, down-conversion or optical parametric generation (OPG), start with one input photon and result in two photons of lower energies. The two generated wavelengths are referred to as signal and idler, of which the signal is the shortest one. When a cavity is used to enhance the efficiency by resonating one or both of the generated fields, the device is called an optical parametric oscillator (OPO).

In three-wave nonlinear processes, maximum output power levels are obtained when the phase-mismatch between the interacting waves is equal to zero. Considering second harmonic generation, the fundamental optical wave travels with a phase velocity c/n_{(ω)} while the generated wave, the second harmonic, propagates with a phase velocity of c/n_{(2ω)}. The driving polarization and the generated field will thus drift in and out of phase relative to each other. Consequently, without phase matching, the accumulated energy of the generated field oscillates as the waves propagate through the nonlinear medium. The distance over which maximum transfer of energy occurs between the fundamental wave and the generated wave is called the coherence length of interaction L_{c}=π/Δk, where Δk=k₃−2k₁=2π(n₃/λ₃−2n₁/λ₁)=4π(n₃−n₁)/λ₁. When Δk=0 the interaction is phase matched and the contributions to the second harmonic wave generated at each point along the nonlinear medium add up in phase with the contributions generated at every other point along the crystal. Consequently the second harmonic field grows linearly with distance in the crystal and its intensity grows quadratically.

Quasi-phase-matching the interacting light beams by spatially modulating the non-linear polarization properties of a crystal (i.e. periodically poling) is a well known technique where the light beam can interact constructively. Reversing the polarization in a second domain/region of the crystal corrects the phase-mismatch between the interacting waves that has accumulated on passing the length of a first domain/region. The temperature dependence of the non-linear polarization properties, however, seriously limits the effectiveness of quasi-phase-matching through periodically poling. As crystal temperature changes the accumulated phase-mismatch between the interacting waves on passing through a domain does not get (fully) compensated by the ½-wave phase-shift seen by the waves in crossing to the next domain. Temperature changes therefore result in a sub-optimal power build up by the generated waves.

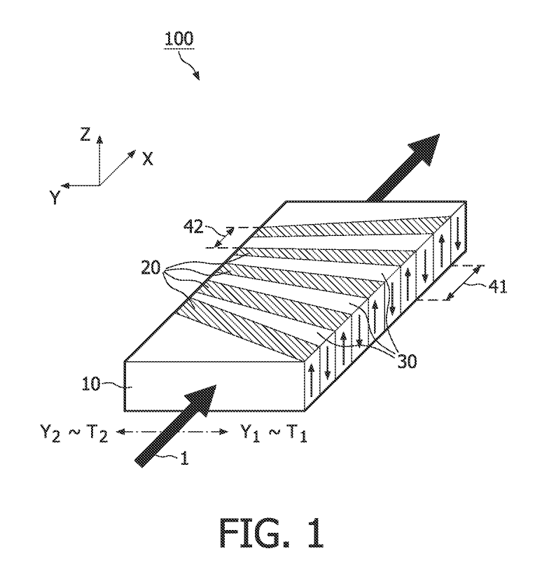

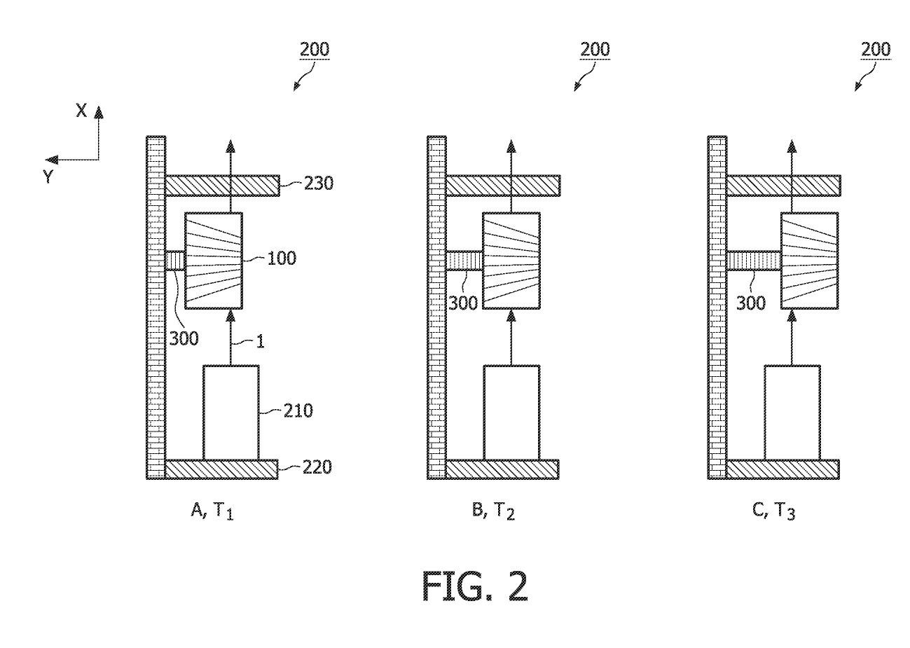

The invention provides a method and device which alleviates the phase matching issues associated with temperature variations of periodically poled non-linear optical crystals. FIG. 1 schematically shows a wavelength converting device 100 according to the invention. The device comprises a non-linear optical crystal 10 arranged to have (in operation) a light beam 1 pass through it along an axis (X) of the crystal. The crystal has periodically poled regions 20,30 with alternating polarity (as indicated by the ‘up’ and ‘down’ arrows, respectively) over the length of the crystal. While the classical approach orients the poled regions 20,30 perpendicular to the axis (X) of the crystal 10, the inventive concepts skews the regions 20,30 in the wavelength converting device 100 relative to the axis (X). As a result, the periods 41,42 of the poled regions along the axis (X) of the device vary in a direction (Y) perpendicular to the axis. Thus, across the width of the crystal 10, at one side the poling period 41 is longer than the period 42 on the other side. Due to the high sensitivity of the non-linear optical parameters to temperature of crystal materials, a particular poling period 41,42 corresponds to a predetermined temperature T₁,T₂, respectively. Consequently, when the crystal 10 has temperature T₁ light beam 1 preferably should pass through the crystal at width position Y₁ to guarantee phase-matching and thus cumulative energy transfer between the interacting light waves. Similarly, at a temperature T₂ light beam 1 preferably should pass through the crystal 10 along axis (X) at a width position Y₂. Therefore, in an embodiment a laser 200 (see FIG. 2) comprises the position of wavelength converting device 100. In another embodiment the position of the wavelength converting device 100 in the laser 200 relative to a light beam 1 is arranged to be adjustable along the direction (Y) perpendicular to the axis (X). To achieve this relative repositioning, the light beam 1 may be kept fixed while translating the wavelength converting device 100. Alternatively, fixing the position of the crystal 10 while optically redirecting the light beam 1 achieves the same result.

Several techniques exist to generate quasi-phase-matched crystals 10 through periodically poling (also known as ferroelectric domain engineering) of ferroelectric non-linear materials such as lithium niobate (LN, LiNbO₃), litium tantale (LT, LiTaO₃) and potassium titanyl phosphate (KTP, KTiOPO₄). These ferroelectric materials exhibit a spontaneous electric polarization P below their Curie temperature as a consequence of charge separation inside the unit cell of the crystal. This charge separation defines the polar axis (Z) of the crystal 10. In ferroelectric domain engineering positioning micro-structured electrodes on at least one side of the crystal 10 (the opposite side usually obtains a homogenous electrode) allows to selectively apply a strong electrical field along the polar axis (Z). The structure of the electrodes thus define the position and form of the resulting polarization domains or poled regions 20,30. Typically the poling period has values between 5 and 50 μm.

Alternative techniques producing ferroelectric domains include (i) electron beam induced spatially modulated charge deposition, (ii) spatially modulated ion implementation (f.i. Ti in LN), and (iii) spatially modulated constituent out-diffusion or exchange (f.i. LiO out-diffusion form LN and Rb/K ion exchange in KTP). While the first technique is relatively time consuming and exhibits a lower reproducibility than electrical field induced poling, the later two techniques result in relatively shallow domain-inverted regions well suited for periodically poled guided-wave structures. A combination of these chemical patterning techniques and the application of a homogenous electrical field can even ameliorate fringing field induced domain irregularities, well known from the patterned electrode technique.

Turning to FIG. 2, it schematically shows an embodiment of a laser 200 comprising a wavelength converting device 100 according to the invention. Laser 200 comprises a gain medium 210, a back reflector 220 and an output coupler 230. The gain medium 210 may comprise a solid state material such as Nd:YAG or Ti:sapphire. Alternatively, it may comprise a gas such as HeNe, Ar, CO₂ or an excimer. Alternatively yet, it may comprise a III-V semiconductor material such as InGaN, AlInGaP or GaAs. In an embodiment the wavelength converting device 100 is an intra-cavity element in which case the back reflector 210 and output coupler 230 form the laser cavity or resonator. In an alternative embodiment, the laser 200 is arranged as an extend cavity laser and the wavelength converting device 100 is arranged inside the extended cavity. As an example, laser 200 may comprise a vertical external cavity surface emitting laser (VECSEL) based on a surface-emitting semiconductor gain chip with a Bragg back-reflector and a partially reflecting front mirror. The output coupler 230 positioned external to the semiconductor gain chip completes the resonator in this embodiment.

FIGS. 2A, B & C show the laser 200 with the position of the wavelength converting device 100 adjusted to optimize the conversion efficiencies at temperatures T₁, T₂ and T₃, respectively. To adjust the position of the wavelength converting device 100 in the laser 200 relative to a light beam 1 in a direction (Y) perpendicular to the axis (X), in an embodiment the wavelength converting device is assembled on a mount 300.

In an embodiment, the mount comprises an electrical element controllable in length, such as a piezo-element. Advantageously, this allows active control of the laser to stabilize the conversion efficiency of a wavelength converting device 100. For this purpose, the laser further comprises appropriate feedback means based on for instance temperature measurements of the wavelength converting device 100 or power measurement of the converted light wave—i.e. the second harmonic wave or the signal wave.

In another embodiment, the mount is arranged to have a calibrated thermal expansion. Advantageously, this allows for stabilization of the conversion efficiency through automatic compensation of temperature variations of the wavelength converting device (100) by displacing it along the direction (Y).

Although the invention has been elucidated with reference to the embodiments described above, it will be evident that alternative embodiments may be used to achieve the same objective. The scope of the invention is therefore not limited to the embodiments described above. Accordingly, the spirit and scope of the invention is to be limited only by the claims and their equivalents.

1. A wavelength converting device comprising a non-linear optical crystal having periodically poled regions with alternating polarity wherein the period of the poled regions along an X-axis of the device vary in a direction (Y) perpendicular to the X-axis.

2. A wavelength converting device according to claim 1, wherein the non-linear optical crystal comprises a material selected from the group consisting of Lithium Niobate (LN), Lithium Tantalate (LT), Litium tri-Borate (LBO), Potassium Titanyl Phosphate (KTP), Potassium Niobate (KN), beta Barium Borate (BBO), and Rubidium Titanyl Arsenate (RTA).

3. A laser comprising a wavelength converting device according to claim 1.

4. A laser according to claim 3, wherein the position of wavelength converting device in the laser relative to a light beam is arranged to be adjustable along the direction (Y) perpendicular to the X-axis.

5. A laser according to claim 4, wherein the laser further comprises a mount on which the wavelength converted device is assembled to allow adjusting its position.

6. A laser according to claim 5, wherein the mount is arranged to have a calibrated thermal expansion allowing for maximization of the conversion efficiency through automatic compensation of temperature variations of the wavelength converting device by displacing it along the direction (Y).

7. A laser according to claim 5, wherein the mount comprises an electrical element controllable in length allowing for maximization of the conversion efficiency.

8. A laser according to claim 4, wherein the laser is arranged as an extend cavity laser and the wavelength converting device is arranged inside the extended cavity.

9. A laser according to claim 4, wherein the wavelength converting device is arranged as an intra-cavity element.

10. A laser according to claim 4, wherein the wavelength converting device is arranged to generate a second harmonic of a fundamental laser wavelength.

11. A laser according to claim 4, wherein the wavelength converting device is arranged to parametrically generate a signal and idler output.

12-13. (canceled)
